(19) United States
(12) Patent Application Publication
(10) Pub. No.: US 2010/0252700 A1
(43) Pub. Date: Oct. 7, 2010

(54) SUCTION CUP ASSEMBLY AND FASTENING DEVICE INCLUDING SUCH SUCTION CUP ASSEMBLY

(75) Inventor: Han-Kai Wang, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/488,044

(22) Filed: Jun. 19, 2009

(30) Foreign Application Priority Data
Apr. 2, 2009 (TW) 098110973

(51) Int. Cl. F16B 47/00

(52) U.S. Cl. 248/206.2

(57) ABSTRACT

A suction cup assembly includes a base, a suction cup, a guiding part and a rotary rod. The base has a first opening, a second opening and a top surface. The guiding part includes a first guiding post having a first inclined slot and a second guiding post having a second included slot. After the first and second guiding posts respectively penetrate through the first and second openings, the first inclined slot and the second included slot are partially exposed. The both terminals of the rotary rod are respectively inserted into the first and second included slots and supported on the top surface of the base. During rotation of the rotary rod, the both terminals of the rotary rod are moved from the lower ends to the upper ends of the first and second included slots, so that the guiding part is uplifted and the suction cup is subject deformation.

### FIELD OF THE INVENTION

The present invention relates to a fastening device, and more particularly to a fastening device including a suction cup assembly for attaching an object on a smooth surface.

### BACKGROUND OF THE INVENTION

In some situations, it is necessary to temporarily attach one object on a smooth surface. For example, when a driver is driving a car, a fastening device is secured to a windshield beside the driver seat in order that a mobile phone, a music player and/or a GPS satellite navigator could be attached on the smooth surface. Generally, the fastening device is equipped with a suction cup. For using the suction cup, the suction cup is pressed on a smooth surface to create a vacuum between the suction cup and the smooth surface, and thus the suction cup is firmly attached on the smooth surface. In addition, the user could pull the edge of the suction cup to introduce air inside the suction cup in order to detach the suction cup from the smooth surface.

For assuring that the suction cup is continuously attached on the smooth surface, the fastening device has a vacuum-creating mechanism. For example, the vacuum-creating mechanism has a plunger drive shaft, and an operating lever or a rotational flange. By operating the operating lever or the rotational flange to uplift the plunger drive shaft, the center portion of the suction cup is pulled away from the smooth surface to create a near vacuum between the center portion of the suction cup and the smooth surface, so that the suction cup is firmly attached on the smooth surface. On the other hand, when the plunger drive shaft is descended to the original position, the suction cup is relaxed and thus the vacuum holding the suction cup against the smooth surface is released.

The fastening device having the above-mentioned vacuum-creating mechanism is disclosed in for example U.S. Pat. Nos. 4,580,751 and 6,666,420. Although the conventional fastening device is effective to create a vacuum between the suction cup and the smooth surface, there are still some drawbacks. For example, since the operating lever or the rotational flange is exposed outside the fastening device and allowed to be pressed or moved by using a single finger or two fingers, a short operating lever or a small movable element becomes hindrance from exerting a force thereon. For facilitating ease of a exerting force, the operating lever could be extended or the movable element could be enlarged. The extension of the operating lever or the enlargement of the movable element, however, is adverse to the overall appearance of the fastening device. In addition, the operating lever or the movable element may be carelessly touched by an external force or a foreign substance.

Therefore, there is a need of providing a fastening device that is easy to use and easy to exert a force thereon, in which the overall appearance of the fastening device is not deteriorated by the suction cup uplifting element.

### SUMMARY OF THE INVENTION

For obviating the drawbacks encountered from the prior art, the present invention provides an easy-to-use fastening device. When a housing member of the fastening device is held by the user's palm, a guiding part of the fastening is uplifted such that a vacuum is created between the suction cup and a smooth surface.

In accordance with an aspect of the present invention, there is provided a suction cup assembly. The suction cup assembly includes a base, a suction cup, a guiding part and a rotary rod. The base has a first opening, a second opening and a top surface. The guiding part is disposed at a middle portion of the suction cup, and includes a first guiding post and a second guiding post. The first guiding post includes a first inclined slot having a first inclined slot upper end and a first inclined slot lower end. The first inclined slot upper end is exposed after the first guiding post penetrates through the first opening. The second guiding post includes a second inclined slot having a second inclined slot upper end and a second inclined slot lower end. The second inclined slot upper end is exposed after the second guiding post penetrates through the second opening. The rotary rod is supported on the upper surface. Both terminals of the rotary rod are respectively inserted into the first inclined slot upper end and the second inclined slot upper end. The both terminals of the rotary rod are respectively moved from the first inclined slot upper end and the second inclined slot upper end to the first inclined slot lower end and the second inclined slot lower end when the rotary rod is rotated in a first rotating direction. During rotation of the rotary rod in the first rotating direction, the guiding part is uplifted and the suction cup is subject deformation.

In an embodiment, the both terminals of the rotary rod are respectively moved from the first inclined slot lower end and the second inclined slot lower end to the first inclined slot upper end and the second inclined slot upper end when the rotary rod is rotated in a second rotating direction. The second rotating direction is reverse to the first rotating direction. During rotation of the rotary rod in the second rotating direction, the guiding part is descended and the suction cup recovers from deformation.

In an embodiment, the first inclined slot lower end has a stopping structure.

In an embodiment, the stopping structure is a horizontal notch.

In accordance with another aspect of the present invention, there is provided a fastening device for fixing an object on a smooth surface. The fastening device includes a connecting member for holding the object, a suction cup assembly and a housing member. The suction cup assembly includes a base, a suction cup, a guiding part and a rotary rod. The base is combined with the connecting member, and has a first opening, a second opening and a top surface. The suction cup is attached on the smooth surface. The guiding part is disposed at a middle portion of the suction cup, and includes a first guiding post and a second guiding post. The first guiding post includes a first inclined slot having a first inclined slot upper end and a first inclined slot lower end. The first inclined slot upper end is exposed after the first guiding post penetrates through the first opening. The second guiding post includes a second inclined slot having a second inclined slot upper end and a second inclined slot lower end. The second inclined slot upper end is exposed after the second guiding post penetrates through the second opening. The rotary rod is supported on the upper surface. Both terminals of the rotary rod are respectively inserted into the first inclined slot upper end and the second inclined slot upper end. The housing member is arranged between the base and the connecting member, and comprising a clamping part for clamping the rotary rod. When the housing member is rotated in a first rotating direction, the rotary rod clamped by the clamping part is rotated in the first rotating direction, the both terminals of the rotary rod are respectively moved from the first inclined slot upper end and the second inclined slot upper end to the first inclined slot lower end and the second inclined slot lower end when the rotary rod is rotated in a first rotating direction, and the guiding part is uplifted, so that a vacuum is created between the suction cup and the smooth surface and the suction cup is firmly attached on the smooth surface.

In an embodiment, when the housing member is rotated in a second rotating direction, the rotary rod clamped by the clamping part is rotated in the second rotating direction, the both terminals of the rotary rod are respectively moved from the first inclined slot lower end and the second inclined slot lower end to the first inclined slot upper end and the second inclined slot upper end, and the guiding part is descended, so that the suction cup is detached from the smooth surface.

In an embodiment, the first inclined slot lower end has a stopping structure.

In an embodiment, the stopping structure is a horizontal notch.

In an embodiment, the connecting member includes a joint.

In an embodiment, the joint is a universal joint.

In an embodiment, the connecting member further includes a hooking element, which is connected with the joint.

In an embodiment, the connecting member further includes a fixing stand, which is connected with the joint.

In an embodiment, the clamping part is a groove structure.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a fastening device according to an embodiment of the present invention;

FIG. 2 is a schematic exploded view of the fastening device according to an embodiment of the present invention;

FIGS. 3A and 3B are schematic perspective views illustrating a process for assembling the suction cup assembly of the fastening device according to an embodiment of the present invention;

FIGS. 3C and 3D are schematic perspective views illustrating operations of the suction cup assembly of the fastening device according to an embodiment of the present invention;

FIG. 4A is a schematic exploded view illustrating the housing member of the fastening device;

FIGS. 4B and 4C are schematic perspective views illustrating the housing member of the fastening device; and

FIG. 5 is a schematic perspective view illustrating another example of the connecting member.

### DETAILED DESCRIPTION OF THE PREFERRED EMBODIMENT

The present invention provides a fastening device for attaching one object on a smooth surface. For example, by means of the fastening device, an electronic device such as a mobile phone, a personal digital assistant, a satellite navigator, a hand-free loudspeaker or a multimedia player could be attached on a smooth surface (e.g. a windshield of a vehicle). In this context, the smooth surface is a surface permitted to be contact with the bottom of a suction cup. The smooth surface is not limited to a flat surface or a curvy surface as long as a vacuum could be created between the bottom of the suction cup and the smooth surface.

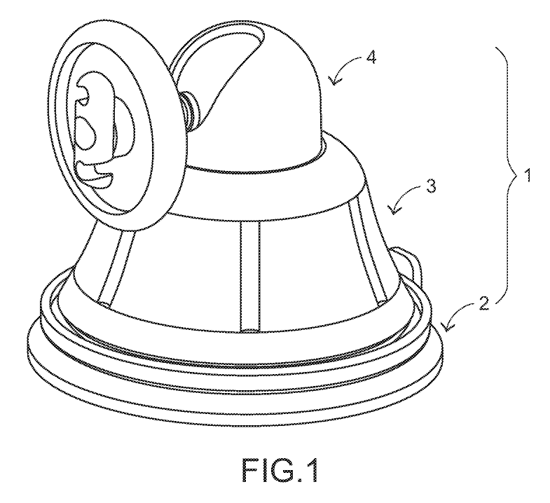

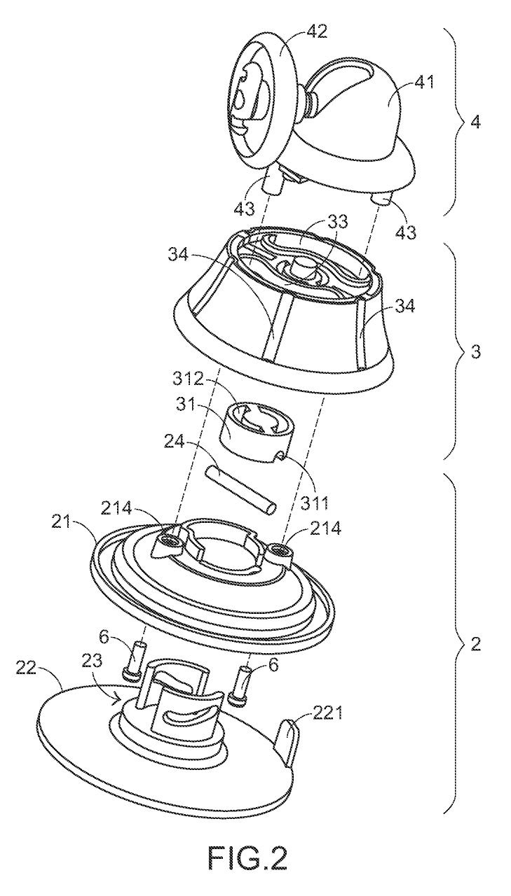

FIG. 1 is a schematic perspective view illustrating a fastening device according to an embodiment of the present invention. FIG. 2 is a schematic exploded view of the fastening device shown in FIG. 1. Please refer to FIG. 1 and FIG. 2. The fastening device 1 comprises a suction cup assembly 2, a housing member 3 and a connecting member 4. The suction cup assembly 2 could be attached on a smooth surface. The connecting member 4 is used to hold an object. The housing member 3 is arranged between the suction cup assembly 2 and the connecting member 4. Via the housing member 3, a near vacuum is created between the suction cup assembly 2 and the smooth surface, so that the suction cup assembly 2 is firmly attached on the smooth surface.

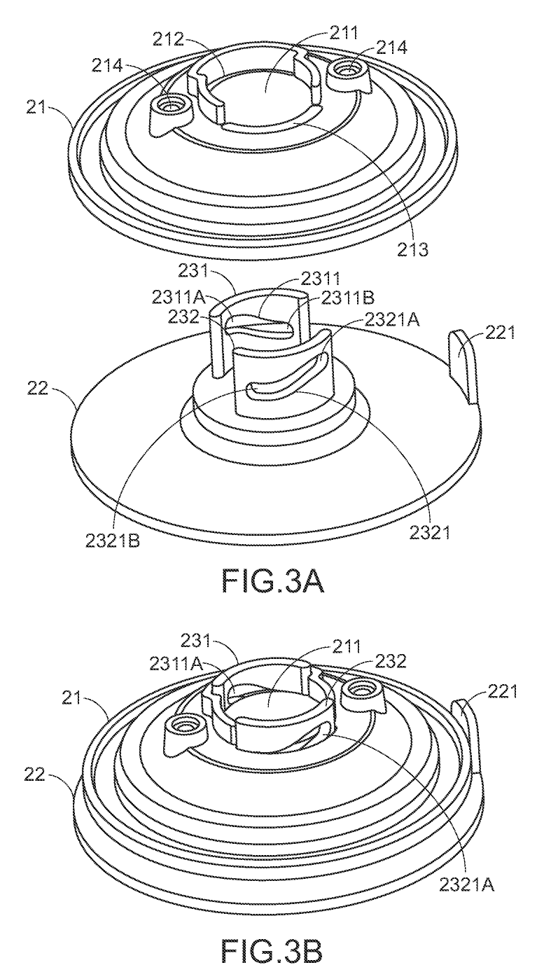

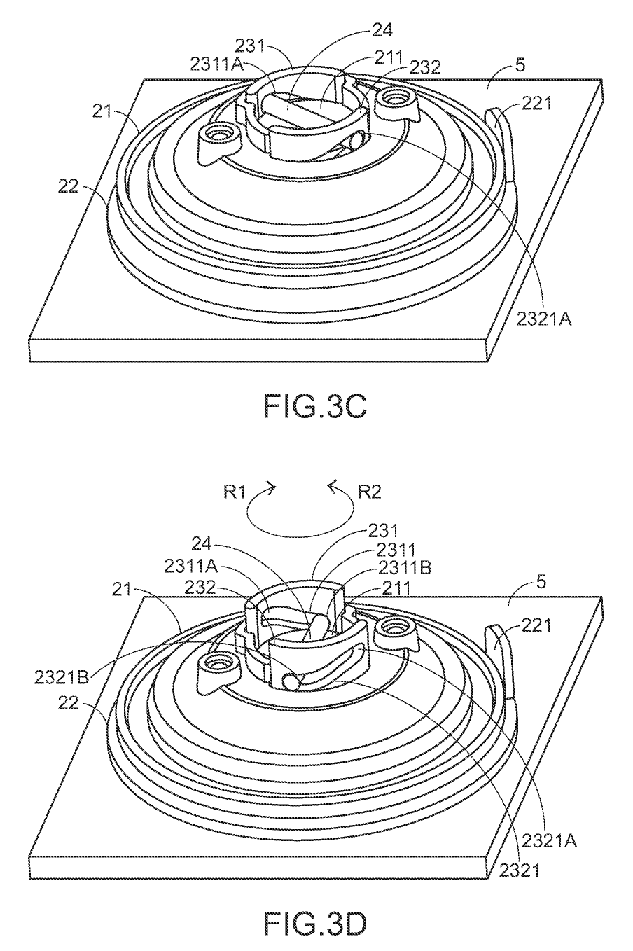

Please refer to FIG. 2. The suction cup assembly 2 includes a base 21, a suction cup 22, a guiding part 23 and a rotary rod 24. The base 21 has a top surface 211, a first opening 212 and a second opening 213 (see also FIG. 3). The guiding part 23 is disposed at the middle portion of the suction cup 22. The guiding part 23 includes a first guiding post 231 and a second guiding post 232 (see also FIG. 3). A first inclined slot 2311 is formed in the first guiding post 231. A second inclined slot 2321 is formed in the second guiding post 232. In this embodiment, the first guiding post 231 and the second guiding post 232 of the guiding part 23 are opposed to each other and have arc-shaped profiles. The first inclined slot 2311 of the first guiding post 231 and the second inclined slot 2321 of the second guiding post 232 are radially arranged at the same level.

A process of successively assembling suction cup 22 and the guiding part 23 with the base 21 will be illustrated in more details with reference to the schematic perspective views of FIGS. 3A, 3B and 3C. As shown in FIG. 3A, the first opening 212 and the second opening 213 of the base 21 are slightly greater than the cross-sectional areas of the first guiding post 231 and a second guiding post 232, respectively. First of all, the first guiding post 231 and the second guiding post 232 of the guiding part 23 penetrate through the first opening 212 and the second opening 213, respectively. As such, the first inclined slot upper end 2311A and the second inclined slot upper end 2321A are exposed (see FIG. 3B). Next, both terminals of the rotary rod 24 are respectively inserted into the first inclined slot upper end 2311A and the second inclined slot upper end 2321A such that the rotary rod 24 is sustained against the top surface 211 of the base 21 (see FIG. 3C). Meanwhile, the suction cup 22, the guiding part 23 and the base 21 are combined together into the suction cup assembly 2.

FIGS. 3C and 3D are schematic perspective views illustrating operations of the suction cup assembly of the fastening device. As shown in FIG. 3C, after the suction cup assembly 2 is produced, the rotary rod 24 is sustained against the top surface 211 of the base 21, wherein the both terminals of the rotary rod 24 are respectively inserted into the first inclined slot upper end 2311A and the second inclined slot upper end 2321A. At this moment, the suction cup assembly 2 is contacted with a smooth surface 5 according to the shape of the suction cup 22. In other words, the suction cup assembly 2 has not been firmly secured to the smooth surface 5. Next, the rotary rod 24 is rotated in the rotating direction R1 while the rotary rod 24 is supported by the top surface 211 of the base 21. As such, the first terminal of the rotary rod 24 is moved along the first inclined slot 2311 and from the first inclined slot upper end 2311A to a first inclined slot lower end 2311B; and the second terminal of the rotary rod 24 is moved along the first inclined slot 2312 and from the second inclined slot upper end 2321A to a second inclined slot lower end 2321B (see FIG. 3D). During rotation of the rotary rod 24 in the rotating direction R1, the guiding part 23 at the middle portion of the suction cup 22 is uplifted and thus the suction cup 22 is subject to deformation. Under this circumstance, a vacuum is created between the bottom of the suction cup 22 and the smooth surface 5, so that the suction cup assembly 2 is firmly attached on the smooth surface 5.

Please refer to FIGS. 3C and 3D again. On the other hand, when rotary rod 24 is rotated in the rotating direction R2 that is reverse to the rotating direction R1, the both terminals of the rotary rod 24 are moved from the first inclined slot lower end 2311B and the second inclined slot lower end 2321B to the first inclined slot upper end 2311A and the second inclined slot upper end 2321A, respectively. During rotation of the rotary rod 24 in the rotating direction R2, the guiding part 23 is descended to its original position. As such, the suction cup 22 is relaxed and the vacuum holding the suction cup 22 against the smooth surface 5 is released. Under this circumstance, the suction cup assembly 2 can be easily detached from the smooth surface 5. Moreover, a tab 221 is extended from the periphery of the suction cup 22. When the suction cup 22 is attached on the smooth surface 5, the user may lift the tab 221 to introduce air inside the space between the suction cup 22 and the smooth surface 5, thereby facilitating easy detachment of the suction cup assembly 2.

In the fastening device 1 of the present invention, the first inclined slot upper end 2311A, the second inclined slot upper end 2321A, the first inclined slot lower end 2311B and the second inclined slot lower end 2321B could be formed with stopping structures. In this embodiment, as shown in FIG. 3A or 3D, the stopping structures are horizontal notches or nearly horizontal notches in order for facilitating positioning the both terminals of the rotary rod 24. Alternatively, the stopping structures are downward indentations. Alternatively, the stopping structures are notches with undercut regions. The downward indentations and the undercut notches are effective to facilitate positioning the both terminals of the rotary rod 24.

In the fastening device 1 of the present invention, the rotation of the rotary rod 24 is driven by the housing member 3. Upon rotation of the housing member 3, the overall appearance of the fastening device is maintained unchanged. When the housing member 3 is held by the user's palm, a tiny torsion force is sufficient to rotate the housing member 3, thereby driving rotation of the rotary rod 24. As such, the suction cup 22 is either firmly attached on the smooth surface 5 or detached from the smooth surface 5.

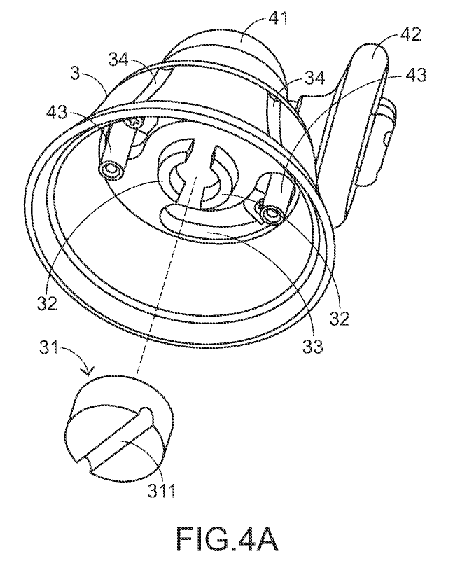

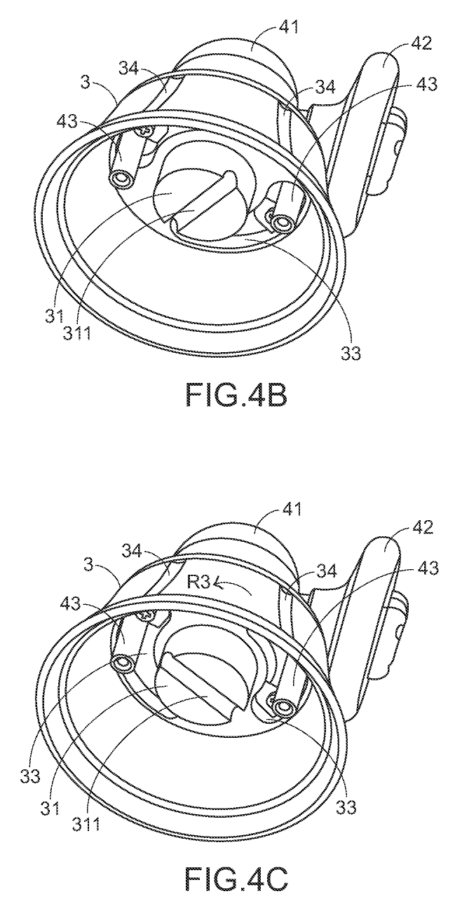

FIG. 4A is a schematic exploded view illustrating the housing member of the fastening device. FIGS. 4B and 4C are schematic perspective views illustrating the housing member of the fastening device. Please refer to the exploded view of the fastening device 1 as shown in FIG. 2 and the exploded and perspective views of the housing member 3 as shown in FIGS. 4A˜4C. The housing member 3 includes a knob 31 and a convex part 32. The knob 31 includes a clamping part 311 and a concave part 312. The clamping groove 311 is formed in the bottom surface of the knob 31 and is formed as a groove structure. Alternatively, the clamping part 311 is consisted of multiple recesses. The concave part 312 is formed in the top surface of the knob 31. An example of the concave part 312 is a recess structure. The shape of the clamping groove 311 of the knob 31 is fitted with the shape of the rotary rod 24, so that the rotary rod 24 is clamped by the clamping groove 311. In other words, the rotary rod 24 is fixed between the clamping groove 311 and the top surface 211 of the base 21. The convex part 32 of the housing member 3 and the concave part 312 of the knob 31 have the complementary shapes. An example of the convex part 32 is a bulge. After the convex part 32 of the housing member 3 and the concave part 312 of the knob 31 are engaged with each other, the knob 31 is combined with the housing member 3 (see FIG. 4B). Since the convex part 32 is engaged with the concave part 312, the knob 31 is rotated with the housing member 3 and the rotary rod 24 is simultaneously rotated with the knob 31. That is, by rotating the housing member 3 in the rotating direction R3 (see FIG. 3C), the rotary rod 24 and the knob 31 are simultaneously rotated in the rotating direction R3.

In this embodiment, since the knob 31 is combined with the internal portion of the housing member 3, the external force applied on the housing member 3 to rotate the housing member 3 could be directly transmitted to the rotary rod 24. It is noted that, however, those skilled in the art will readily observe that numerous modifications and alterations of the knob 31 may be made while retaining the teachings of the invention. For example, the knob has a convex part and the housing member 3 has a concave part mating with the convex part, so that the knob 31 could be combined with the internal portion of the housing member 3. In some embodiments, the knob 31 having a clamping groove 311 is integrally formed with the internal portion of the housing member 3.

Please refer to FIGS. 1 and 2 again. In the fastening device 1, a fastening hole 214 is formed in the base 21 of the suction cup assembly 2, an aperture 33 is formed in the housing member 3, and a stud 43 (or a bolt hole) is formed on the connecting member 4. The fastening hole 214, the aperture 33 and the stud 43 are aligned with each other. By penetrating a screws 6 through the fastening hole 214 and then tightening the screws 6 in the studs 43, the suction cup assembly 2, the housing member 3 and the connecting member 4 are combined together. Please refer to FIGS. 4B and 4C. The aperture 33 of the housing member 3 has an arc-shaped profile. Due to the arc-shaped profile of the aperture 33, the stud 43 of the connecting member 4 is permitted to penetrate through the aperture 33 to be combined with the base 21 of the suction cup assembly 2 and the rotation of the housing member 3 is not hindered by the stud 43. In an embodiment, one or more anti-slip grooves 34 are formed in the outer surface of the housing member 3 for facilitating ease rotation of the housing member 3. In some embodiments, some anti-slip articles (e.g. rubbery articles) are adhered on the outer surface of the housing member 3 or some salient points are formed on the outer surface of the housing member 3 in order to achieve the anti-slip purpose and facilitate ease rotation of the housing member 3.

Please refer to FIG. 2 again. Depending on the size or the shape of the object to be held by the connecting member 4, the connecting member 4 is varied. In this embodiment, the connecting member 4 includes a joint 41 and a hooking element 42 connected with the joint 41. An example of the joint 41 is a universal joint. Alternatively, the joint 41 is a hinge. In this embodiment, after the hooking element 42 of the connecting member 4 is engaged with a corresponding fastening recess (not shown) of the object, the object is fixed on the fastening device 1.

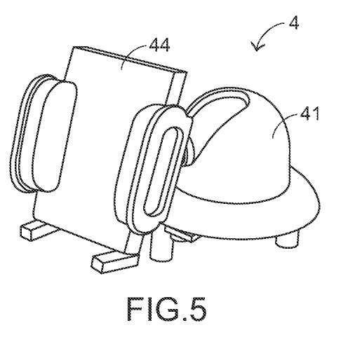

FIG. 5 is a schematic perspective view illustrating another example of the connecting member 4. As shown in FIG. 5, the connecting member 4 includes a joint 41 and a fixing stand 44. The fixing stand 44 is connected to the joint 41 for supporting the object.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A suction cup assembly comprising:
a base having a first opening, a second opening and a top surface;
a suction cup;
a guiding part disposed at a middle portion of said suction cup, and comprising:
a first guiding post comprising a first inclined slot having a first inclined slot upper end and a first inclined slot lower end, wherein said first inclined slot upper end is exposed after said first guiding post penetrates through said first opening; and
a second guiding post comprising a second inclined slot having a second inclined slot upper end and a second inclined slot lower end, wherein said second inclined slot upper end is exposed after said second guiding post penetrates through said second opening; and
a rotary rod supported on said upper surface and having both terminals respectively inserted into said first inclined slot upper end and said second inclined slot upper end,
wherein said both terminals of said rotary rod are respectively moved from said first inclined slot upper end and said second inclined slot upper end to said first inclined slot lower end and said second inclined slot lower end when said rotary rod is rotated in a first rotating direction, and said guiding part is uplifted and said suction cup is subject deformation during rotation of said rotary rod in said first rotating direction.

2. The suction cup assembly according to claim 1 wherein said both terminals of said rotary rod are respectively moved from said first inclined slot lower end and said second inclined slot lower end to said first inclined slot upper end and said second inclined slot upper end when said rotary rod is rotated in a second rotating direction which is reverse to the said first rotating direction, and said guiding part is descended and said suction cup recovers from deformation during rotation of said rotary rod in said second rotating direction.

3. The suction cup assembly according to claim 1 wherein said first inclined slot lower end has a stopping structure.

4. The suction cup assembly according to claim 3 wherein said stopping structure is a horizontal notch.

5. A fastening device for fixing an object on a smooth surface, said fastening device comprising:
a connecting member for holding said object;
a suction cup assembly comprising:
a base combined with said connecting member, and having a first opening, a second opening and a top surface;
a suction cup attached on said smooth surface;
a guiding part disposed at a middle portion of said suction cup, and comprising a first guiding post and a second guiding post, wherein said first guiding post includes a first inclined slot having a first inclined slot upper end and a first inclined slot lower end, said first inclined slot upper end is exposed after said first guiding post penetrates through said first opening, said second guiding post includes a second inclined slot having a second inclined slot upper end and a second inclined slot lower end, and said second inclined slot upper end is exposed after said second guiding post penetrates through said second opening; and
a rotary rod supported on said upper surface and having both terminals respectively inserted into said first inclined slot upper end and said second inclined slot upper end; and
a housing member arranged between said base and said connecting member, and comprising a clamping part for clamping said rotary rod,
wherein when said housing member is rotated in a first rotating direction, said rotary rod clamped by said clamping part is rotated in said first rotating direction, said both terminals of said rotary rod are respectively moved from said first inclined slot upper end and said second inclined slot upper end to said first inclined slot lower end and said second inclined slot lower end, and said guiding part is uplifted, so that a vacuum is created between said suction cup and said smooth surface and said suction cup is firmly attached on said smooth surface.

6. The fastening device according to claim 5 wherein when said housing member is rotated in a second rotating direction, said clamping part clamped by said clamping part is rotated in said second rotating direction, said both terminals of said rotary rod are respectively moved from said first inclined slot lower end and said second inclined slot lower end to said first inclined slot upper end and said second inclined slot upper end, and said guiding part is descended, so that said suction cup is detached from said smooth surface.

7. The fastening device according to claim 5 wherein said first inclined slot lower end has a stopping structure.

8. The fastening device according to claim 7 wherein said stopping structure is a horizontal notch.

9. The fastening device according to claim 5 wherein said connecting member includes a joint.

10. The fastening device according to claim 9 wherein said joint is a universal joint.

11. The fastening device according to claim 9 wherein said connecting member further includes a hooking element, which is connected with said joint.

12. The fastening device according to claim 9 wherein said connecting member further includes a fixing stand, which is connected with said joint.

13. The fastening device according to claim 5 wherein said clamping groove is a groove structure.
